(19) United States
(12) Patent Application Publication
(10) Pub. No.: US 2024/0219881 A1
(43) Pub. Date: Jul. 4, 2024

(54) METHOD OF COMMUNICATION WITH A PROGRAMMABLE LOGIC CONTROLLER SYSTEM

(71) Applicant: HYUNDAI AUTOEVER CORP., Seoul (KR)

(72) Inventors: Jooyoung Jung, Seoul (KR); Siwan Kim, Seoul (KR); MinJae Kim, Seoul (KR)

(73) Assignee: HYUNDAI AUTOEVER CORP., Seoul (KR)

(21) Appl. No.: 18/545,468

(22) Filed: Dec. 19, 2023

(30) Foreign Application Priority Data
Dec. 29, 2022 (KR) 10-2022-0188944

(51) Int. Cl. G05B 19/05

(52) U.S. Cl. CPC G05B 19/05; G05B 2219/1214

(57) ABSTRACT

A method of communication with a programmable logic controller (PLC) system, performed by a computing device. The method includes converting a plurality of tags into a same operation unit, including blocking the plurality of tags by aligning each tag according to an offset, and putting the blocks in a window corresponding to a protocol data unit (PDU). A determination may be made whether or not to split a block that is put in the window.

### CROSS-REFERENCE TO RELATED APPLICATIONS

This application claims the benefit of and priority to Korean Patent Application No. 10-2022-0188944, filed on Dec. 29, 2022, the entire contents of which are hereby incorporated by reference in its entirety.

### FIELD

Embodiments relate to a method of communication with a programmable logic controller (PLC) system and to a communication method capable of optimizing the number of communication with a PLC system.

### BACKGROUND

A programmable logic controller (PLC) may be used in industrial sites requiring factory automation, and may serve as the main controller of a product-manufacturing facility or production line.

In the use of a PLC system, communication is performed between a computing device and the PLC system to obtain or write data desired by a user.

This communication may be in the form of reading/writing data from/to a memory area of the PLC system in a protocol data unit (PDU).

FIG. 1 depicts an example of the command types of PDUs, which are broadly divided into a single block approach and a multiple block approach. The single block approach may be divided into a single offset approach and a batch offset approach. The single block approach may access only a single area within a PDU without exceeding the maximum data size, whereas the single offset approach may access only a single offset address and the batch offset approach may access consecutive offset addresses.

The multiple block approach is a method allowing access to offset addresses remote from multiple areas within a single PDU without exceeding the maximum data size.

Typically, users create and use objects called tags as logical units for data communication with a PLC system, tags are named for their purposes and have attributes specifying the memory area, offset address, and data size to be accessed.

Conventional communication methods with PLC systems usually provide only a protocol to communicate data on A-tag-by tag basis, limiting the input values so that the maximum data size is not exceeded in a single tag. Therefore, it is inconvenient for users to configure logical logic within the specifications defined by each protocol.

### SUMMARY

Embodiments provide a method of communication with a programmable logic controller (PLC) system, capable of preprocessing data to optimize the number of communication without limiting the size of data in A-tag.

In an embodiment, a method of communication of a computing device with a programmable logic controller (PLC) system includes converting a plurality of tags into the same operation unit including blocking the plurality of tags by aligning each tag according to an offset. The method of communication further includes putting the blocks in a window corresponding to a protocol data unit (PDU) including determining whether to split a block.

In the step of putting the blocks in the window, the blocks corresponding to tags may be sequentially put in the window with a predetermined size. Whether or not to split the block may be determined if only a portion of a block is put in the window.

In the step of putting the blocks in the window a leading block located first in the window may be allowed to be split.

In the step of putting the blocks in the window the bock may not be allowed to be split if the block includes a size not larger than the size of the window and corresponds to the last block.

In the step of putting the blocks in the window, the block may be allowed to be split if the block includes a size not larger than the size of the window, if the effective size of valid data included in the window is larger than estimated total padding cost, and if the size of the block to be split, which is put in an existing window, is equal to or larger than the incurred padding cost.

In the step of putting the blocks in the window, the block may not be allowed to split if the effective size of the valid data included in the window is larger than the estimated total padding cost, or if the size of the block to be split, which is put in the existing window, is smaller than the incurred padding cost.

In the step of putting the blocks in the window when the size of the block is larger than the size of the window, the block may be allowed to be split if the size of the block to be split, which is put in a new window, is within the size of the window. The block may not be allowed to be split when the size of the block to be split, which is put in the new window, is larger than the size of the window.

The method may further include converting, by a computing device, one window into one PDU to perform communication with the PLC system.

The computing device may be configured to identify one window into one block container, and convert the one block container into one PDU to perform communication with the PLC system. Each tag is configured to subscribe to one or more block containers.

The computing device may process the converted PDU in a queueing manner.

The communication method with the PLC system according to the present disclosure does not limit the data size of A-tag and optimizes the number of communication by converting a plurality of tags into the same operation unit. The communication method further determines whether to split the block and performs data preprocessing to allow for embedment in a window corresponding to a PDU.

### BRIEF DESCRIPTION OF THE DRAWINGS

FIG. 1 depicts a diagram of a command type of a PDU according to an embodiment of the present disclosure.

FIG. 2 depicts a diagram of a system in which a method of communication with a programmable logic controller (PLC) system according to an embodiment of the present disclosure is performed.

FIG. 3 depicts a flow diagram of the method of communication with the PLC system according to an embodiment of the present disclosure.

FIG. 4 depicts a flow diagram of data conversion to a main operation unit in the method of communication with the PLC system according to an embodiment of the present disclosure.

FIGS. 5 to 9 depict diagrams of a block-split operation for the method of communication with the PLC system according to an embodiment of the present disclosure.

FIGS. 10 and 11 depict diagrams of a container subscription manner in a method of communication with the PLC system according to an embodiment of the present disclosure.

FIGS. 12 to 14 depict diagrams of a queuing manner in the PLC system according to an embodiment of the present disclosure.

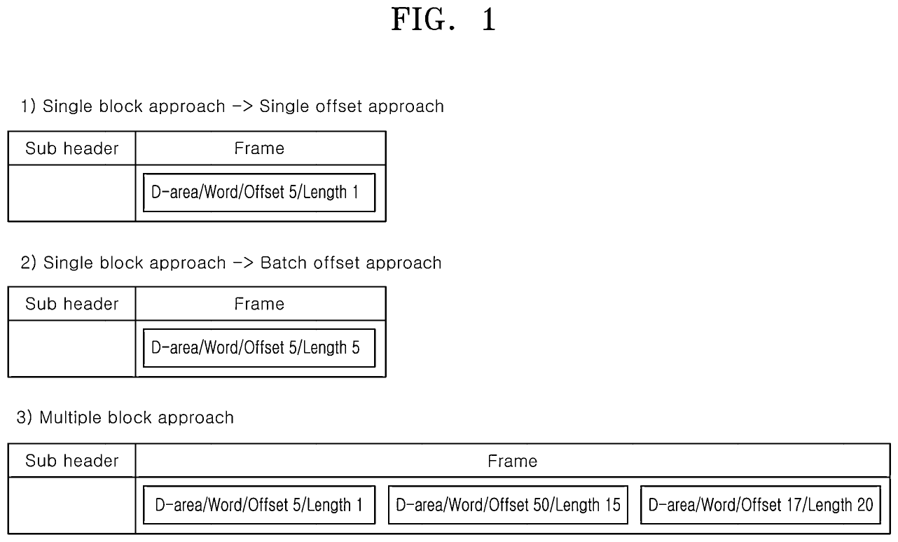

### DETAILED DESCRIPTION

Hereinafter, a method of communication with a programmable logic controller (PLC) system according to the present disclosure is described with reference to the accompanying drawings through various embodiments. In the description, the thickness of the lines or the size of the components depicted in the drawings may be exaggerated for clarity and convenience of explanation. In addition, the terms to be described later are terms defined in consideration of functions in the present disclosure, which may vary according to the user or operator's intention or practices in the art. Therefore, definitions of these terms should be made based on the content throughout this specification.

In the following description, when a component, device, element, or the like of the present disclosure is described as having a purpose or performing an operation, function, or the like, the component, device, or element should be considered herein as being “configured to” meet that purpose or perform that operation or function.

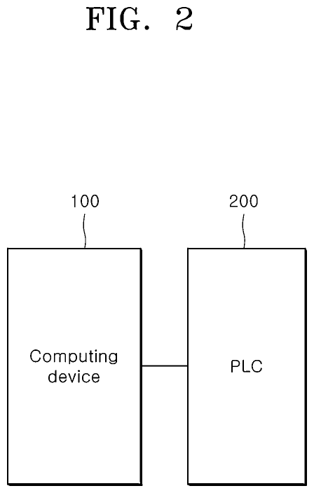

FIG. 2 is a diagram depicting a system in which a method of communication with a programmable logic controller (PLC) system according to an embodiment of the present disclosure is performed. As depicted in FIG. 2, a computing device 100 is configured to communicate with a PLC 200 and to process data to perform the communications as described in the present disclosure.

The computing device 100 may include a processor, a memory connected to the processor, an input interface such as a keyboard, mouse, touch screen, or the like, and an output interface such as a display. Processing data to perform communication in the present disclosure may be performed by the processor.

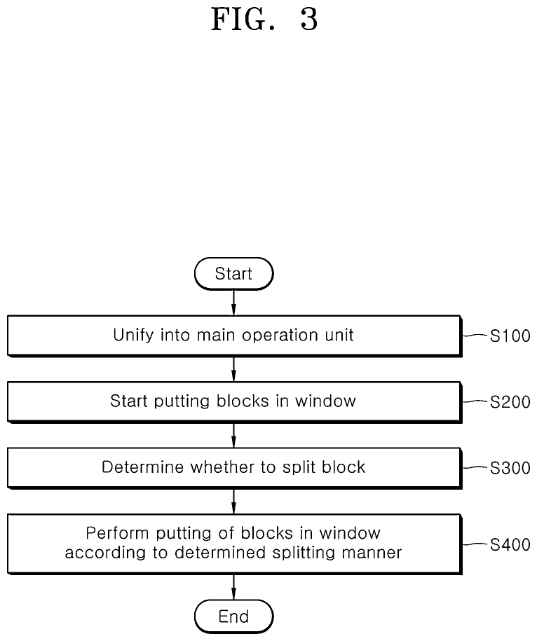

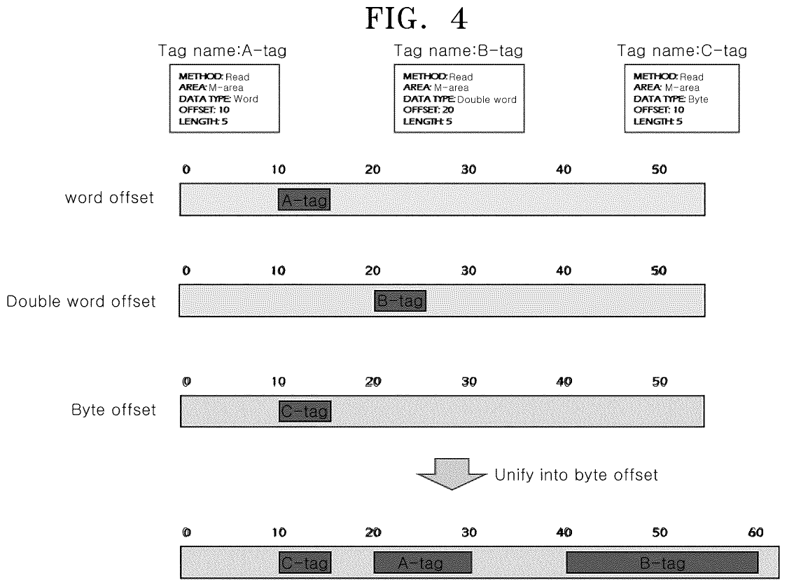

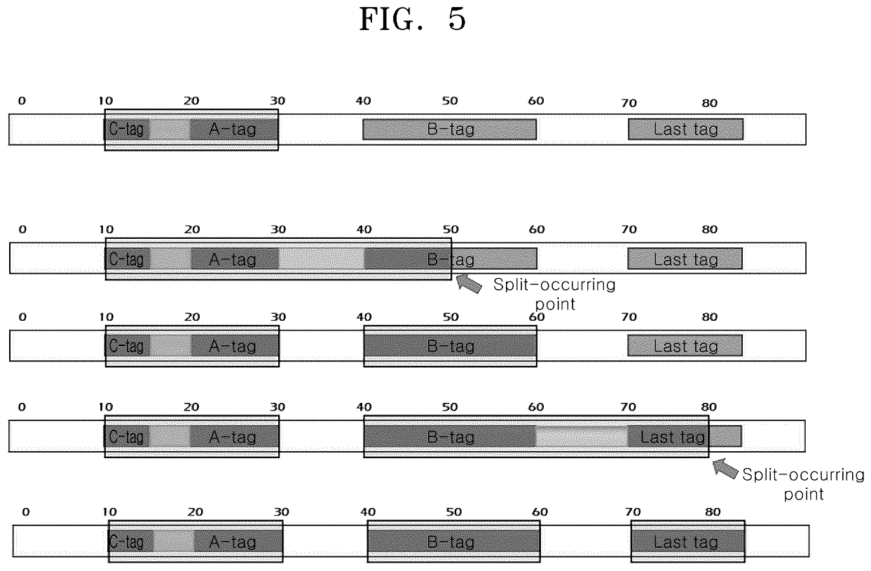

FIG. 3 is a flow diagram depicting a method of communication with the PLC system according to an embodiment of the present disclosure. FIG. 4 is a flow diagram depicting data conversion to a main operation unit in the method of communication with the PLC system according to an embodiment of the present disclosure. FIGS. 5 to 9 are diagrams depicting a block-split operation in the method of communication with the PLC system according to an embodiment of the present disclosure.

As depicted in FIG. 3, the computing device 100 first converts (unifies) a plurality of tags into a main operation unit (S100).

As depicted in FIG. 4, since the data type of each tag may be different, the offset may be converted by converting into a single operation unit.

For example, when converting into bytes, bits may be converted into bytes via upcast, and words and double words may be converted into bytes via downcast.

As depicted in FIG. 4, the transformed list is divided into memory regions and sorted in ascending order with respect to a leading offset.

In the case of a protocol that provides a multi-block access command, merging may be performed between tags that are immediately adjacent (i.e., the offset interval is 1). That is, after merging adjacent tags, multiple blocks may be included up to the data size that may be accessed at once in a multi-block command, thereby reducing the number of communication.

In the case of providing a batch offset access command, the computing device 100 generates a window with a data size that may be accessed (processed) at once, and then starts the operation of putting tags as elements (S200). At this time, whether to split a block whose size is out of the window size is determined (S300), and the block is put in the window according to the determined split method (S400).

At this time, the determination of whether to split the block is made as follows.

First, if a block is a leading block located first in a window, then the block is allowed to be split. Furthermore, if the block has a size not larger than the maximum limit size of the window and the block is the last block, then the block is not allowed to be split. Here, if the block is not allowed to be split, then the existing window is closed and a new window is created to put the block into.

If the block has a size not larger than the maximum limit of the window and is not the last block, then it is determined whether the effective size of the window is larger than the estimated total padding cost. If the effective size is larger than the estimated total padding cost and the size of a first half of the split block is equal to or larger than the incurred padding cost, then the splitting is allowed. If the effective size is not greater than the estimated total padding cost, or if the size of the first half of the split block is less than the incurred padding cost, then the splitting is not allowed.

If the size of the block is larger than the maximum limit size of the window and the size of a second half of the split block is within the maximum limit size of the window, then the splitting is allowed. If the size of the block is larger than the maximum limit size of the window and the size of the second half of the split block is larger than the maximum limit size of the window, then the splitting is not allowed.

In this way, when it is necessary to request only consecutive offset data in one PDU (batch offset access), data may be read at once by filling in the empty offset gap. Furthermore, offsets between distant requests may be put in different PDUs instead of being combined to avoid unnecessary memory access.

FIGS. 5 through 9 are diagrams that depicts the block division operation of a communication method with a PLC system according to an embodiment of the present disclosure.

FIG. 5 is an example assuming a maximum data size of 40 bytes. A C-tag and an A-tag are located within the window size, so the C-tag and A-tag are included in turn. This incurs a padding cost of reading an unnecessary offset (current padding cost: 5).

Attempting to include a B-tag within the window size results in a split of the B-tag. The window must be used once more in some way. Whether to allow the split or start a new window is determined by the criteria above.

(1) Assuming the split, the B-tag is not a leading block, and its size is within the window limit. (2) Assuming the split, the estimated total padding cost is 15 and the estimated total effective size in the window is 25. (3) The padding cost incurred in the split assumption is 10 and the expected size of a first half of the split block is 10. Therefore, the splitting is not allowed. The existing window is closed.

The entire split B-tag is put in a new window (current padding cost: 5).

When the last tag is put in the existing window, judgement for the split is required. Since the tag (1) is within the window size limit and (2) is the last element, the existing window is closed, and the tag is put in a new window.

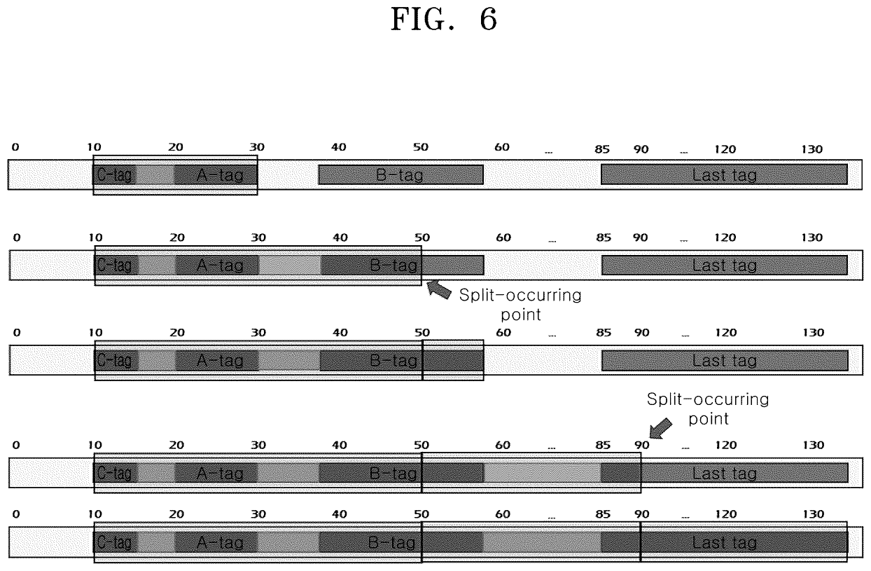

FIG. 6 depicts a variation of FIG. 5 in which the start offset position of the B-tag and the size of the last tag are changed. This example assumes a maximum data size of 40 bytes.

The C-tag and the A-tag are located within the window size, so the C-tag and A-tag are put one after the other in the window. This incurs a padding cost of reading an unnecessary offset (current padding cost: 5).

If the B-tag needs to be put within the window size limit, the B-tag will be split. (1) Assuming the split, the B-tag is not a leading block, and its size is within the window limit. (2) Assuming the split, the expected total padding cost of the split is 12.5 and the expected total effective size within the window is 27.5. (3) The padding cost incurred in the split assumption is 7.5 and the expected size of the first half of the split block is 12.5. Therefore, the splitting is allowed.

A second half of the split B-tag is put in a new window (current padding cost: 12.5).

When the last tag is put in the existing window, the judgement for the split is required. (1) The last tag is not a leading block, and its size is 50, which exceeds the window limit of 40. (2) The size of the second half of the split is 40, which is within the window limit of 40. Therefore, the splitting is allowed.

The second half of the last tag is put in a new window.

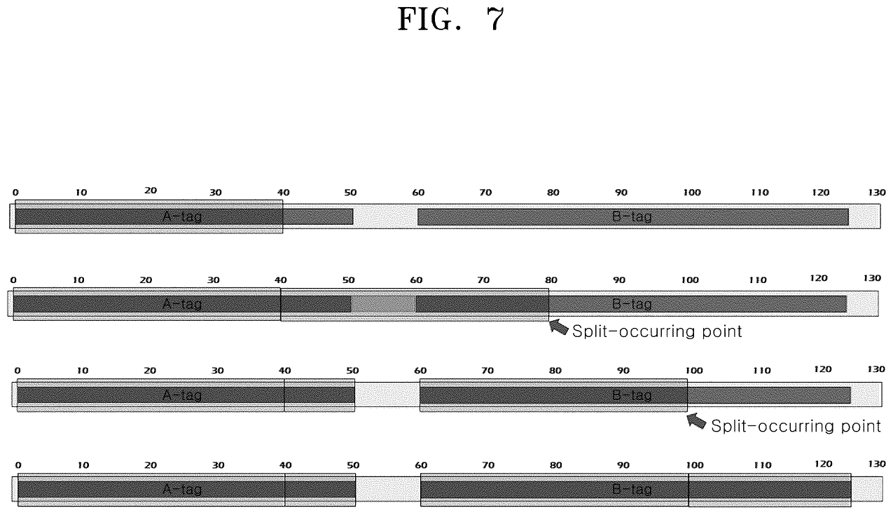

FIG. 7 depicts an example of a block that exceeds the maximum window size.

The first half of the A-tag is put in the window. The A-tag is split because it is the leading block in the window (current padding cost: 0).

When the second half of the split A-tag is first put in the window, followed by the B-tag, the judgement for the split is required. (1) The estimated padding cost is 10 and the size of the second half of the split B-tag is 45. (2) The size of the second half of the split B-tag is 45, which exceeds the next window limit size of 40. Therefore, the splitting is not allowed. The existing window is closed.

The first half of the split B-tag is put in a new window. The tag is a leading tag, so the splitting is allowed.

The second half of the split B-tag is put in a new window.

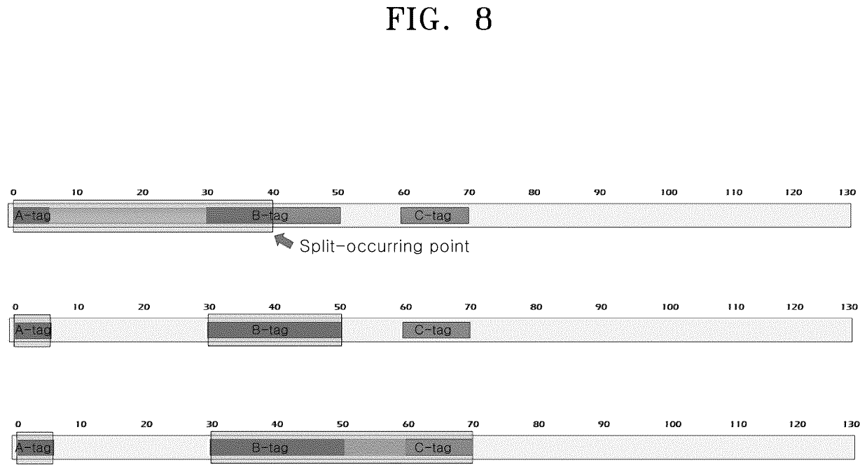

FIG. 8 is an example of disallowing splitting because of the high estimated padding cost.

When the A-tag and the B-tag are sequentially put in the window, the judgement for the split is required. (1) Assuming the split, the B-tag is not a leading block, and its size is within the window limit. (2) The expected total padding cost is 25 and the expected total effective size within the window is 15. Therefore, the splitting is not allowed.

The B-tag is put in a new window (current padding cost: 0).

The last C-tag is put in the existing window. The tag may be included in the existing window without being split (current padding cost: 10).

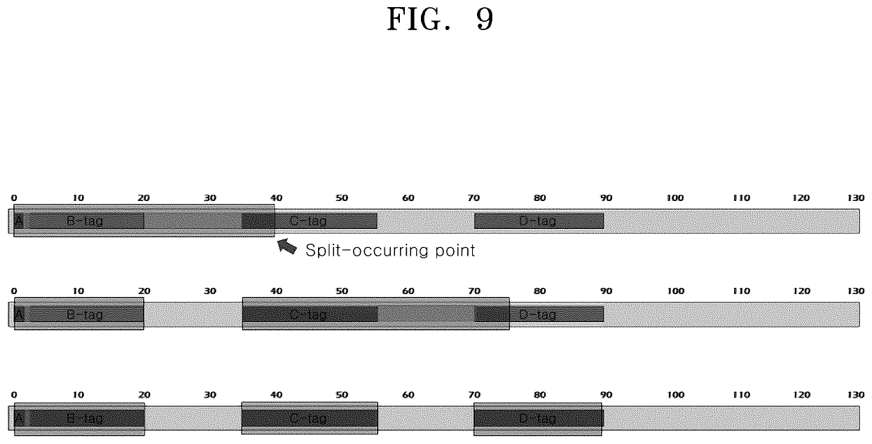

FIG. 9 is another example of disallowing splitting due to the high estimated padding cost.

When the A-tag and the B-tag are sequentially put in the window and then the C-tag is put in the window, the judgement for the split is required. (1) Assuming the split, the C-tag is not a leading block, and its size of 20 is within the window limit of 40. (2) Assuming the split, the estimated total padding cost is 16 and the estimated total effective size in the window is 24. (3) The padding cost incurred under the split assumption is 15 and the expected size of the first half of the split is 5. Therefore, the splitting is not allowed.

When the C-tag and then a D-tag are put in the window, the judgement for the split is required (current padding cost: 1).

The size of the D-tag is 20, which is within the maximum window size limit. Further, the D-tag is the last element, the D-tag is not allowed to be split. The last D-tag is put in a new window. (Current padding cost: 1)

In this way, the blocks are put in respective windows, wherein one window may correspond to data constituting one PDU.

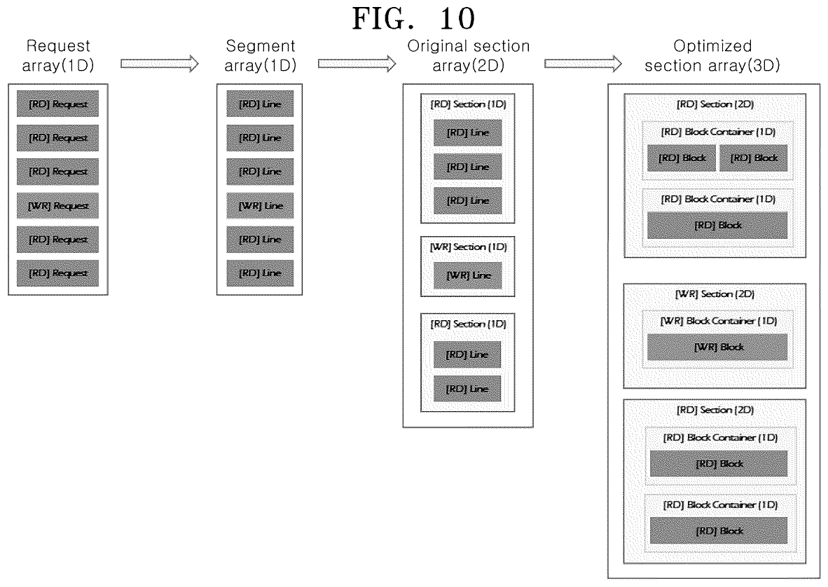

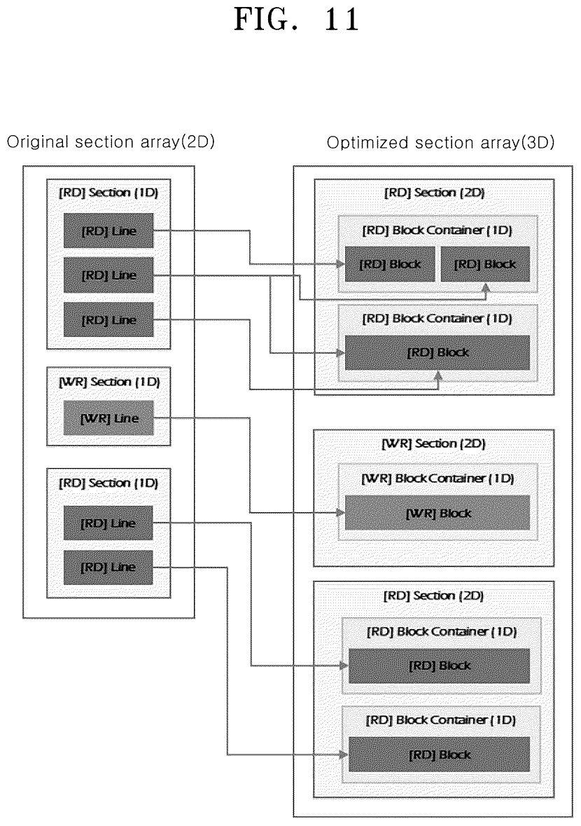

FIGS. 10 and 11 depict diagrams of a container subscription manner in the method of communication with the PLC system according to an embodiment of the present disclosure.

In the present disclosure, the data constituting one PDU, i.e., one window, may be implemented as one block container. Each request (each request according to a tag) may be associated with one or more containers according to the split of the block and may be implemented to subscribe to such containers and output a response to the request when the data processing by such containers is completed, thereby implementing a container subscription method.

As depicted in FIG. 10, the request array may be batch converted to a line segment object and represented as a line segment array, which may be compartmentalized according to read and write methods to form an original section array. That is, since errors may occur if the order of the sections is changed in the case of a write method, the sections are identified based on the write method. The blocks are arranged (optimized section array) so that data transmission is completed with an optimized number of communication using the above-described data preprocessing method for tags.

Each section arrangement may be implemented to subscribe to a corresponding block container and may be configured to respond a result for request when communication with all subscribed block containers is complete.

Specifically, a list of block containers that may contain one or more in a single PDU and a memory area are distinguished, and a list of blocks sorted in ascending order of leading offsets within each area is obtained. Each block includes the leading offset and size in the form of information (key:value) and contains information about which block container it belongs to in the entire block container list and its position in the block list held by the container.

The tag list searches for the starting block by performing a binary search based on the leading offset with reference to the block list and declares a subscription only for the data size that the tag needed based on the position of the block. If one block does not meet the size required by the tag, it moves to the next block and declares a subscription for the required data size. This process is repeated until a tag fully meets its required size.

After all tags have completed their subscriptions, each container block list is converted into a PDU buffer and communication is performed. Upon successful communication, the response PDU buffer is parsed into data, and the result is notified to the tag.

Each tag updates its cache memory at the moment it receives all the response data for the block that the tag subscribed to.

The computing device 100 repeatedly performs communication at a specified interval targeting the block container list and repeats the response data notification.

In this way, even if there was no restriction on the maximum data size when creating the tag, it is possible to perform split communication processing that satisfies the data size that the tag wanted to access.

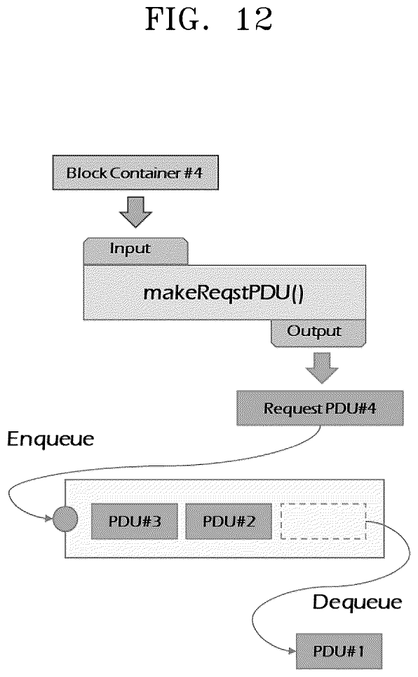

FIGS. 12 to 14 depict diagrams of a queuing manner in the PLC system according to an embodiment of the present disclosure.

FIG. 12 depicts a job processing process through a queue. One block container is converted into one PDU. The converted PDUs are stored in the queue in order, and the PDU at the very front of the queue is taken out for communication.

By using this queue method and setting a waiting time, the communication request interval may be adjusted, and communication may be performed by adjusting the order of PDUs through a priority queue.

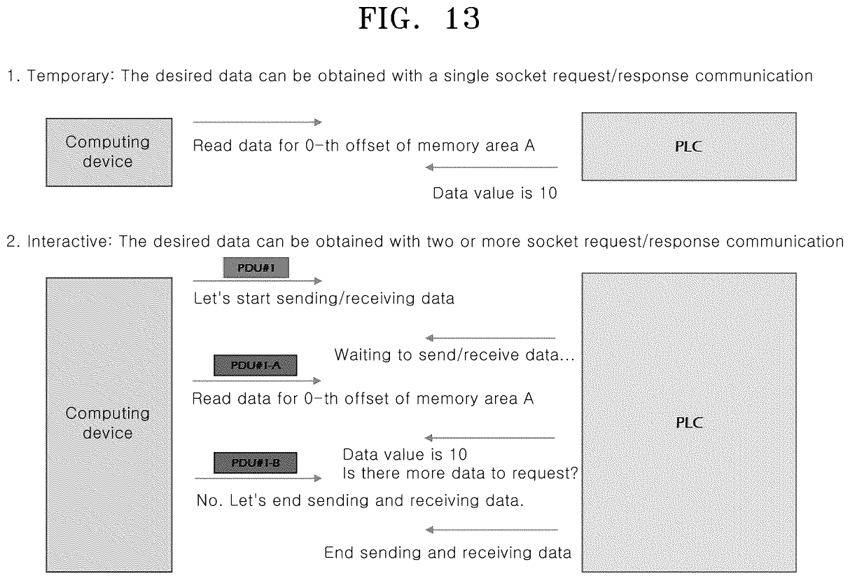

The priority queue is more advantageous for protocols that exchange packets interactively. When another data request is sent before all packet exchanges are completed in the interactive case as depicted in FIG. 13, the PLC 200 responds with an error.

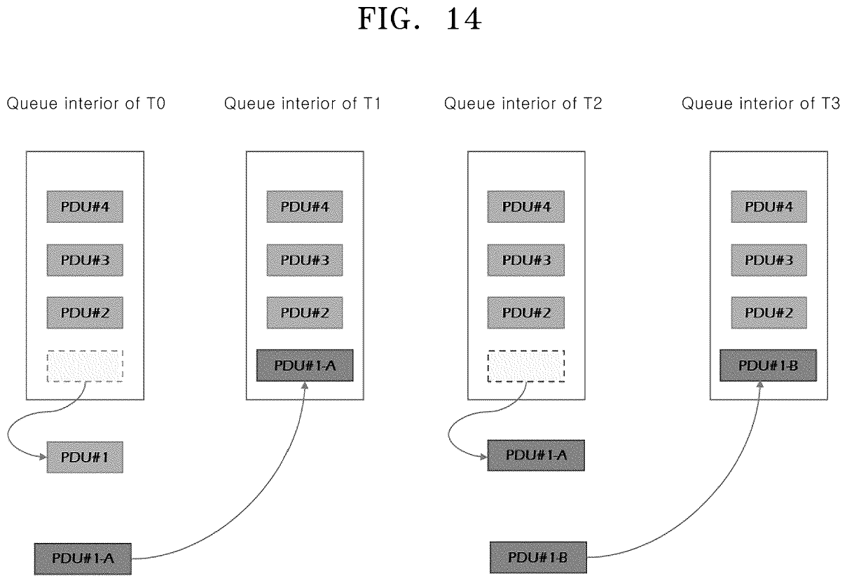

Accordingly, as depicted in FIG. 14, after communication, the PDU derived from PDU #1 is placed at the very front of the queue, and again after communication, the PDU derived from PDU #1-A is placed at the very front of the queue to perform communication processing in an interactive protocol.

While the present disclosure has been described with reference to the embodiments depicted in the drawings, these embodiments are only, and one having ordinary knowledge in the art to which the present technology pertains will understand that various modifications and other equivalent embodiments are possible from them. Therefore, the scope of technical protection of the present disclosure should be defined by the following claims.

What is claim is:

1. A method of communication with a programmable logic controller (PLC) system, performed by a computing device, the method comprising:
converting a plurality of tags into a same operation unit by generating blocks of the plurality of tags where each of the plurality of tags is aligned according to an offset;
determining whether or not to split one or more of the blocks; and
putting the one or more blocks and/or one or more split blocks in a window corresponding to a protocol data unit (PDU).

2. The method of claim 1, wherein the blocks corresponding to the plurality of tags are sequentially put in the window with a predetermined size, wherein a respective block is determined to be split when only a portion of the respective block is to be put in the window.

3. The method of claim 2, wherein determining comprises determining that the respective block is to be split when the respective block is a leading block located first in the window.

4. The method of claim 2, wherein determining comprises determining that a respective block is not split when the respective block has a size not larger than the size of the window and corresponds to a last block in the window.

5. The method of claim 2, wherein determining comprises determining that a respective block is not split when the respective block has a size not larger than a size of the window, when an effective size of valid data included in the window is larger than estimated total padding cost, and when the size of the block to be split, which is put in an existing window, is equal to or larger than an incurred padding cost.

6. The method of claim 5, wherein the respective block is not split when the effective size of the valid data included in the window is larger than the estimated total padding cost or if the size of the respective block to be split that is put in the existing window is smaller than the incurred padding cost.

7. The method of claim 2, wherein a respective block is split when a size of the respective block is larger than the size of the window and when the size of the block to be split that is put in a new window is within the size of the new window; wherein the respective block is not split when the size of the respective block to be split that is put in the new window is larger than the size of the new window.

8. The method of claim 1, further comprising:
converting, by the computing device, one window into one PDU to perform communication with the PLC system.

9. The method of claim 8, further comprising:
identifying, by the computing device, one window for one block container; and
converting, by the computing device, the one block container into a PDU to perform communication with the PLC system, wherein each tag is configured to subscribe to one or more block containers.

10. The method of claim 8, further comprising:
processing, by the computing device, the converted PDU in a queue waiting manner.
